(19) United States
(12) Patent Application Publication
(10) Pub. No.: US 2003/0225566 A1
(43) Pub. Date: Dec. 4, 2003

(54) JTAG server

(76) Inventors: James J. O'Brein, Hull, MA (US); Eric Gregori, Lindenhurst, IL (US)

Correspondence Address: Sampson & Associates, P.C., 50 Congress Steet, Boston, MA, 02109, US

(21) Appl. No.: 10/160,914

(22) Filed: Jun. 3, 2002

(51) Int. Cl. G06F 9/455

(52) U.S. Cl. 703/24

(57) ABSTRACT

A method and system is provided for emulating individual JTAG devices in a multiple device boundary scan chain. One or more target devices within the scan chain are selected, and other devices within the scan chain may be placed into bypass mode. Emulation sequences are sent to a buffer in a server, and subsequently sent to the scan chain, so that the emulation sequences bypass the other device(s) and are executed by the target device(s).

### RELATED APPLICATIONS

This application is related to U.S. patent application Ser. No. 09/921,250, entitled Multiple Device Scan Chain Emulation/Debugging, filed Aug. 2, 2001, which claims the benefit of U.S. Provisional Application Ser. No. 60/252,316, filed Nov. 21, 2000. This application is also related to U.S. patent application Ser. No. 10/083,224, entitled Multi-Core Controller filed Feb. 26, 2002.

### BACKGROUND

JTAG (Joint Test Action Group) Boundary Scan Architecture has been used for many years to enable convenient testing of multiple board-mounted devices. This architecture utilizes the concept of placing a series of cells forming a serial shift register, around the boundary of a device. This shift register is known as a boundary-scan register. The JTAG Boundary Scan Architecture has been standardized in an international standard known as the IEEE 1149.1 “Test Access Port and Boundary-Scan Architecture”. As used herein, the terms “JTAG”, “JTAG compliant”, and/or “IEEE 1149.1 ” are interchangeably used to refer to this standard (including subsequent revisions and modifications thereof) and/or devices that are compliant with this standard.

The boundary-scan cells forming the boundary-scan register essentially formed a series of “virtual nails”, which may be used to test the presence, orientation, and bonding of devices in place on a board. In particular, the prime function of the bed-of-nails in-circuit tester, and thus, the boundary-scan architecture, has been to test for manufacturing defects, such as missing devices, damaged devices, open and short circuits, misaligned devices, and wrong devices. JTAG Boundary Scan Architecture is discussed in greater detail in U.S. patent application Ser. No. 09/921,250, entitled Multiple Device Scan Chain Emulation/Debugging, filed 8/2/2001 (the '250 application), which is filly incorporated by reference herein.

With the proliferation of complex board mounted systems, it became desirable to effect in-depth testing of individual components. A method and apparatus for emulating and/or debugging individual devices using scan chain architecture was disclosed in the '250 patent Application.

A need exists, however, for a tool that provides the ability to conveniently access multiple devices on a single scan chain ring for various reasons, such as to control and manipulate multiple devices, and to have multiple debug sessions active simultaneously. In addition, it is desirable for this tool to have the ability to load FPGAs, EPLDs (Erasable Programmable Logic Device), and other programmable devices, to reduce or eliminate the need for multiple device programmers and emulation hardware.

### SUMMARY

One aspect of the present invention includes a method for emulating individual devices in a multiple device chain. The method includes effecting a session, which includes selecting at least one target device within the chain, and actuating a server having a transmit buffer. The method further includes creating emulation sequences configured for execution by the at least one target device, recording the emulation sequences in the transmit buffer, and transmitting the recorded emulation sequences to the scan chain, so that the emulation sequences pass at least one other device on the scan chain and are executed by the target device.

Another aspect of the invention includes a graphical user interface (GUI) for an emulator configured to emulate individual devices in a multiple device chain. The GUI includes a user-selectable list of devices, a graphical display of the chain, at least one chain parameter field, and a session field configured for identifying each of a plurality of emulation sessions.

A still further aspect includes a system for emulating individual JTAG devices in a multiple device boundary scan chain. The system includes a topology module configured to obtain the topology of the scan chain, and a selection module coupled to said topology module, the selection module configured to select a target device within the scan chain. The system also includes a server having a transmit buffer, and an emulation instruction module configured to generate emulation sequences configured for execution by the at least one target device. The server is configured to record the emulation sequences in the transmit buffer, and to transmit the emulation sequences from the transmit buffer to the scan chain, so that the emulation sequences pass the other device and are executed by the target device.

A yet further aspect of the invention includes a system for emulating individual JTAG devices in a multiple device boundary scan chain. The system includes an operating system module which includes a topology module configured to obtain the topology of the scan chain, a selection module configured to select a target device within the scan chain, and an emulation instruction module configured to generate emulation sequences configured for execution by the target device and to bypass at least one other device for execution by the target device. The system also includes at least one driver coupled to the operating system, and a server having a transmit buffer. The server is configured to record the emulation sequences in the transmit buffer, and to transmit the emulation sequences from the transmit buffer to the scan chain, so that the emulation sequences bypass the other device and are executed by the target device.

### BRIEF DESCRIPTION OF THE DRAWINGS

The above and other features and advantages of this invention will be more readily apparent from a reading of the following detailed description of various aspects of the invention taken in conjunction with the accompanying drawings, in which:

FIG. 1 is a schematic representation of system under test using an embodiment of the present invention;

FIG. 2 is a functional block diagram of an emulator which incorporates an embodiment of the present invention;

FIGS. 3 and 4 are schematic representations, on an enlarged scale, of portions of the embodiment of FIG. 2;

FIGS. 5A and 5B are a flow chart of various operations performed by embodiments of the present invention;

FIGS. 6-10 are screen displays of a graphical user interface of an embodiment of the present invention; and

FIGS. 11 and 12 are screen displays of a graphical user interface of an alternate embodiment of the present invention.

### DETAILED DESCRIPTION

Referring to the figures set forth in the accompanying drawings, the illustrative embodiments of the present invention will be described in detail hereinbelow. For clarity of exposition, like features shown in the accompanying drawings shall be indicated with like reference numerals and similar features as shown in alternate embodiments in the drawings shall be indicated with similar reference numerals.

Embodiments of the present invention include a JTAG server 108 for use in a tool (e.g., an emulator) 110, which enables devices on a multiple device scan chain ring to be individually targeted and controlled or otherwise manipulated. For example, the devices may be targeted for emulation/debugging operations. Tool 110, equipped with JTAG server (or layer) 108, advantageously enables multiple debug sessions to be active simultaneously. As used herein, the term ‘session’ refers to a connection and/or series of communications between the tool 110 and an individual device, such as for example, a debugging session. These multiple debug sessions may include multiple debug sessions on a single host system 112, or on unique systems 112, 114. Moreover, the tool may be used to load FPGAs, EPLDs, and other programmable devices, to nominally eliminate the need for having additional discrete programming and/or emulating tools.

Embodiments of tool 110 may be directly coupled to a host system, such as by incorporation of the tool into the visionPROBE™ hardware-assisted debugging & test tool products available from Wind River Systems, Inc. (Wind River) of Alameda, Calif. Alternatively, tool 110 may be accessed via a network, such as by incorporation of the tool 110 within the visionICE™ real-time in-circuit emulator, also available from Wind River Systems, Inc.

Embodiments of the present invention utilize JTAG compliant instructions (also referred to as sequences), as set forth in the above-referenced '250 application, that utilize conventional boundary scan input and output cells to selectively bypass individual devices in the serial scan chain ring, to enable one or more selected devices to be coupled through the scan chain ring to the emulator/debugger 110. Examples of JTAG enabled (also referred to as JTAG compliant) devices that may be used in conjunction with embodiments of the present invention include the 6xx, 7xx and 82xx family of processors available from Motorola® (Palatine, Ill.), as well as Mcore (Motorola), POWERPC® (International Business Machines Corporation ‘IBM’, Armonk, N.Y.), 4xx (IBM), MIPS® (Mips Technologies, Inc., Mountain View Calif.), Xscale (Intel), and ARM (Arm Limited, Cambridge, England) processors.

Embodiments of the present invention may be used with other types of devices, such as IEEE 1149.1 compatible devices capable of in-circuit PAL, FLASH, FPGA, and EPLD programming. These alternative embodiments may provide features such as boundary scan signal display and in-circuit testing.

Where used in this disclosure, the term “emulator” is used in a manner familiar to those skilled in the art, namely, to refer to hardware and/or software configured to enable a host processor to run software designed for a target processor, and which may include a source-level debugger. For example, the term “emulator” may include the aforementioned visionICE™ real-time in-circuit emulator, and/or visionPROBE™ hardware-assisted debugging & test tool products available from Wind River, alone or in combination. Such an emulator, modified in accordance with embodiments of the present invention as described herein, is referred to as “emulator 110”.

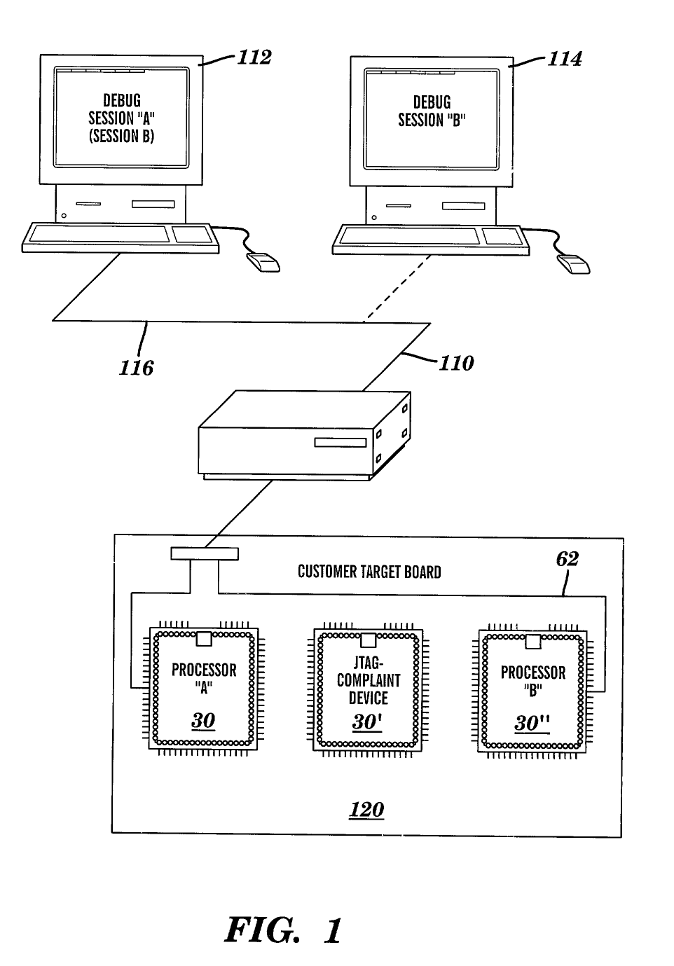

Referring now to Figures, embodiments of the present invention will be more thoroughly described. Turning to FIG. 1, in an exemplary embodiment, one or more discrete host systems 112, 114, are connected via connection 116 to an emulator 110. The emulator is connected to a target board 120 which, in this example, includes three devices on a single scan chain 62, namely, two processors 30, 30″, and an FPGA 30′.

Host systems 112, 114 may include a PC, workstation, terminal, or other similar device having a user interface such as a display and some form of input device (e.g., keyboard, mouse, touch screen, etc.). Connection 116, as mentioned hereinabove, may include a direct connection to a parallel port or USB port of a PC 112, 114. In this configuration, emulator 110 maybe embodied in the VisionPROBE™ tool described above. Alternatively, connection 116 may include a network (e.g., LAN, WAN, or Internet), such as connected to systems 112, 114 via an Ethernet port or the like. In this latter configuration, emulator 110 may be embodied within the VisionICE™ tool.

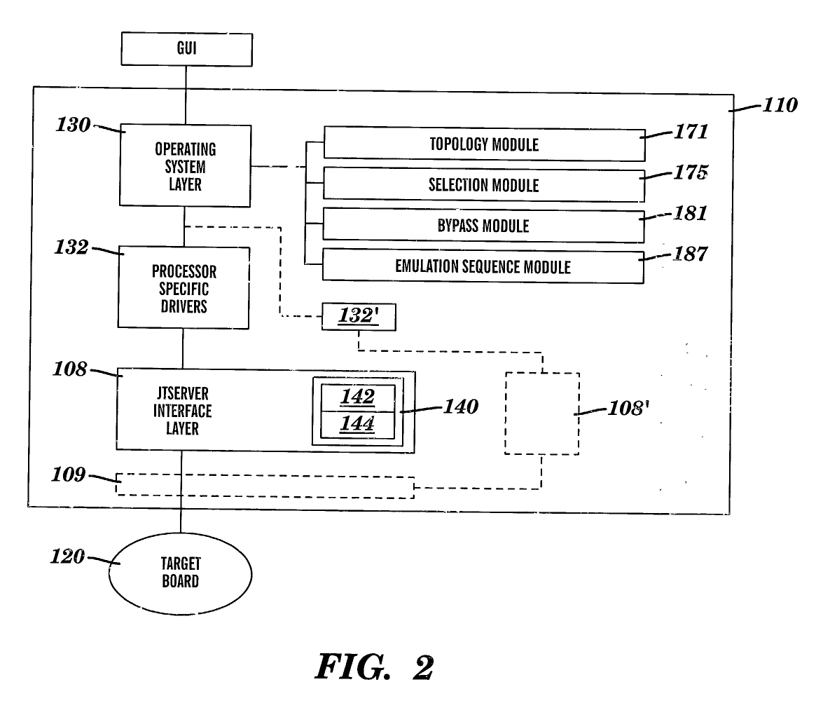

Advantageously, the configuration shown in FIG. 1 may be used to interface two source level debug sessions (e.g., one session for each host system 112, 114), and to provide programmability for the FPGA. This functionality is provided by JTAG server 108 (FIG. 2) which in particular embodiments, is a low level software layer disposed between the target board and the processor-specific drivers, as will be described in greater detail hereinbelow. This layer 108 provides the control needed to position data correctly onto the scan chain 62 in compliance with the IEEE 1149.1 specification for multiple devices on a single scan chain. Layer 108 provides this control in part, by using the topology of the scan chain 62 to determine the position of instructions within a data stream.

This use of the scan chain topology to tailor the bit stream is described in detail in the above-referenced '250 application. Briefly described, this approach includes creating a board description file which specifies the topology of the target board's scan chain layout. This file may be generated manually, i.e., by direct user input, or may be generated by a high level GUI application such as that of the visionCLICK™ (Wind River) or visionXTREME™ (Wind River) tool. An exemplary board description file (in XML format) is shown in Table 1 below:

TABLE 1

<DEVICE_TABLE MODE=“SLOW” CLOCK=“12mhz”
MULTI=“ENABLE”>

<!--This is a sample board description file.-->
<!--Set the MODE to SLOW for now-->
<!--Set TCLK to 12 mhz-->
<!--Enable MULTIple devices on a chain-->
<DEVICE>

<NAME>PPC750 </NAME>
<DESIGNATOR>U1 </DESIGNATOR>
<TYPE>CPU_A </TYPE>
<IR_LEN> 8 <IR_LEN>

</DEVICE>
<DEVICE>

<NAME>XC9536XL </NAME>
<DESIGNATOR> U2 </DESIGNATOR>
<TYPE>FPGA </TYPE>
<IR_LEN> 9 </IR_LEN>

</DEVICE>
<DEVICE>

<NAME>PPC75O </NAME>
<DESIGNATOR> U3 </DESIGNATOR>
<TYPE> CPU B </TYPE>
<IR_LEN> 8 </IR_LEN>

</DEVICE>
<DEVICE>

<NAME/>
<DESIGNATOR/>
<TYPE/>
<IR_LEN/>

</DEVICE>

</DEVICE_TABLE>

The board description file of Table 1 describes the three devices that comprise the topography of board 120 in FIG. 1. The first device 30, is designated CPU_A, and has an instruction register length of 8 bits. The second device 30′ is an FPGA with an instruction register length of 9 bits. The third device 30″ is CPU_B, which has an instruction register length of 8 bits. The total Instruction Register (IR) length of the scan chain 62 is 25 bits. The location of each device in the scan chain may be determined based on its position in the board description file.

In the embodiments shown, server 108 is instantiated, or otherwise actuated, once for each session, e.g., once for each device to be controlled. Multiple instances of server 108 may be used to control multiple sessions for one or more devices. The skilled artisan will recognize that any number of instances of server 108 may be used, provided emulator 110 has sufficient hardware resources available.

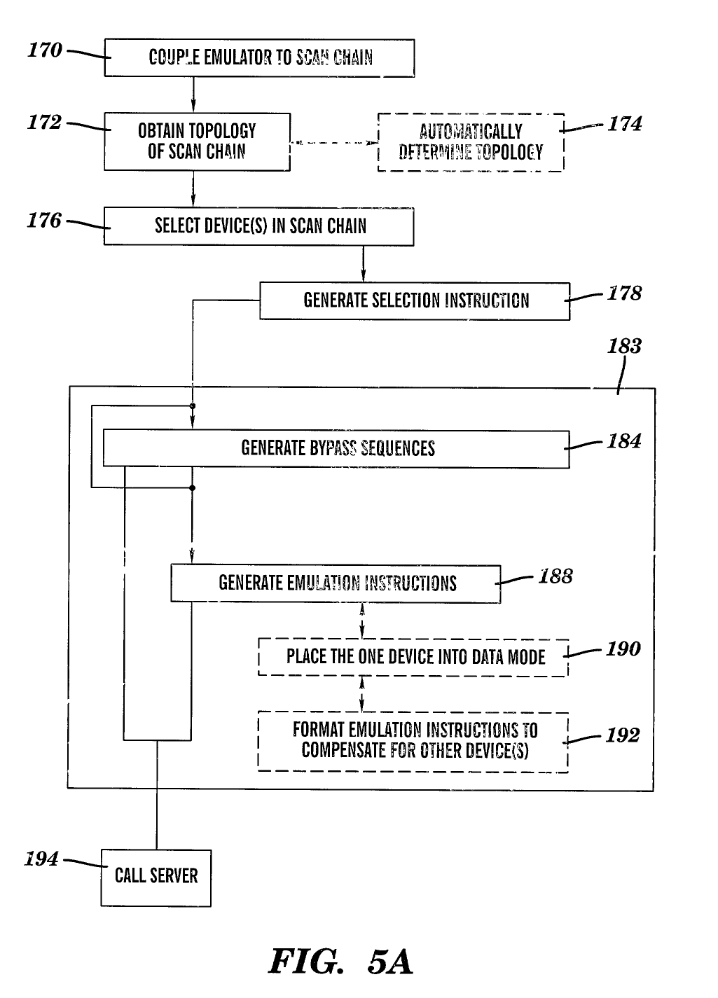

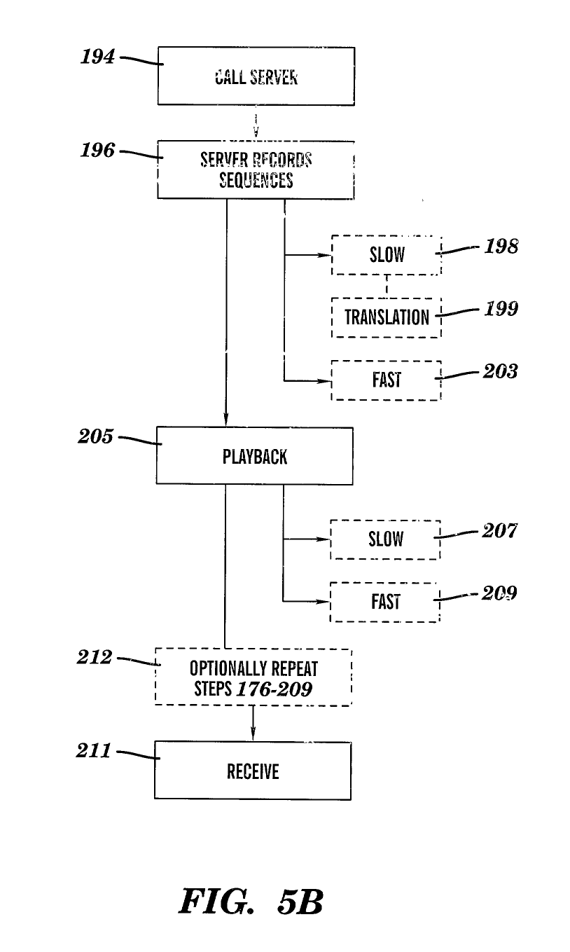

Turning now to FIG. 2, emulator 110 and server 108 are described in greater detail. As discussed hereinabove, server or layer 108 is disposed between the target board and the higher layers of the system such as the operating system (OS) layer 130 of emulator 110. OS layer 130 controls data flow to and from all external communication devices (including host system 112, 114 of FIG. 1). OS 130 also controls the data flow to and from the target board 120, i.e., via processor-specific drivers (also referred to as driver layer) 132. In the embodiment shown, OS layer 130 includes a topology module 171 configured to obtain 172 (FIG. 5A) the topology of the scan chain, and a selection module 175 configured to select 176 (FIG. 5A) at least one target device within the scan chain. Optionally, a bypass module 181 is configured to generate bypass sequences 184 (FIG. 5A) to place at least one other device within the scan chain into bypass mode. An emulation sequence module 187 is also included, to generate 188 (FIG. 5A) emulation sequences for transmission to the scan chain where they bypass the unselected device(s) and are executed by the target device(s), as will be discussed in greater detail hereinbelow with respect to FIGS. 5A and 5B.

As shown, driver layer 132 is logically located beneath the OS layer, and includes specific sequences used to interface the OS layer 130 to the target board 120. These driver sequences are specific to the particular processor manufacturer, and typically include sequences familiar to those skilled in the art, such as those used to access Instruction and Data Registers of the particular devices. Multiple instances of driver layer (e.g., multiple drivers) 132 may be used to interface multiple devices 30, 30′, 30″, etc.

Server (also referred to as server interface layer) 108, is logically disposed between the driver layer 132 and target board 120, to provide an additional level of control. Server 108 receives control sequences from the processor-specific driver 132 and loads each sequence into a high-speed buffer 140, which includes a transmit buffer 142 and a receive buffer 144. Buffer 140 may be implemented in hardware, software, or a combination thereof. Buffer 140 may be integrated within server 108, 108′, as shown, or alternatively, may be disposed as a discrete component communicably coupled to the server.

The Server 108 operates using a notional record and playback strategy. During operation, Server 108 receives sequences from the driver layer 132, and processes each sequence by loading them into transmit buffer 142. Once the sequences for a specific task are loaded, the Server transmits (e.g., ‘plays back’) the contents of transmit buffer 142 to target 120. Similarly, data (e.g., responsive data) generated by target 120 may be received by receive buffer 144. Examples of such received data include status data (e.g., of a register), memory data, or register data.

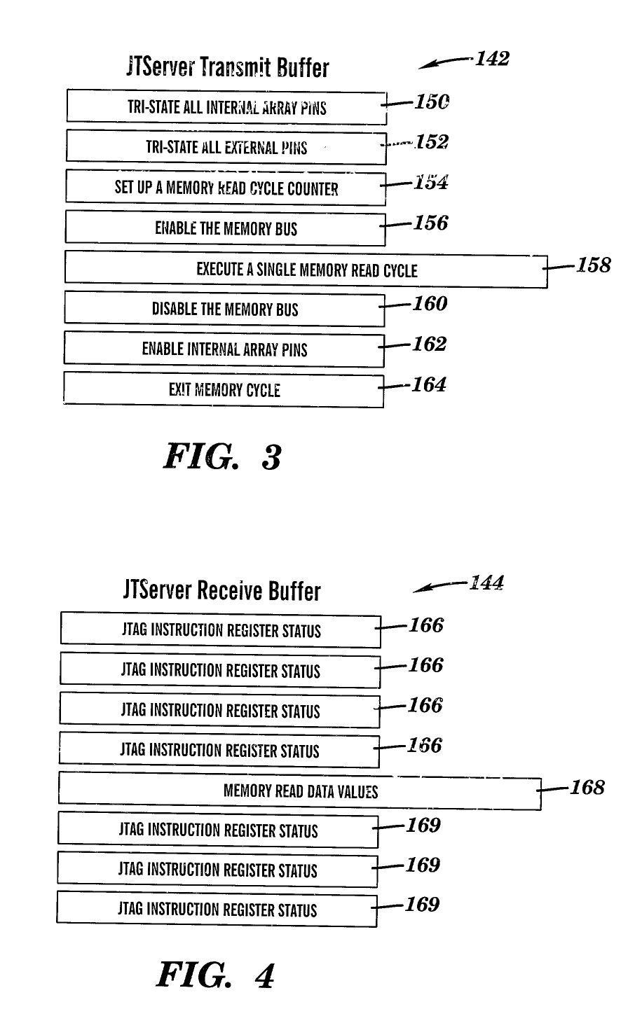

An exemplary task performed by Server 108 is shown and described with reference to FIGS. 3 and 4. For example, server 108 may be used to effect the task of taking read data from a memory location on the target board 120. For commercially available JTAG compliant processors, this task generally requires multiple sequences of preparation followed by implementation of a memory read cycle, followed again by multiple sequences that place the processor back into its normal state.

As shown in FIG. 3, a typical ‘memory read’ task requires four short setup or control JTAG sequences prior to the memory read sequence. In the ‘memory read’ example, these sequences include: tri-stating all internal array pins 150; tri-stating all external pins 152; setting up a memory read cycle counter 154; and enabling the memory bus 156. The memory read sequence 158 is followed by three more short sequences used to place the processor back to its normal state. These three sequences include: disabling the memory bus 160; enabling internal arrays 162; and exiting the memory cycle 164. Once all of these sequences are loaded into transmit buffer 142, they are transmitted to target 120.

In general, for each sequence executed, the target 120 will generate a response. The receive buffer 144 collects these responses as shown in FIG. 4. In the memory read example discussed above, since the first four transmitted sequences 150, 152, 154, 156, were for setup or control, the first four responses received by receive buffer 144 are respective JTAG Instruction Register status responses 166. The response to the memory read sequence 158 contains the memory read data values 168 from the memory of target 120. JTAG Instruction Register Status responses 169 are received in responses to sequences 160, 162, 164.

Referring again to FIG. 2, as mentioned hereinabove, although the foregoing description shows and describes a single instance of driver 132 and server 108, in alternate embodiments, additional drivers 132′ and/or servers 108′ (as shown in phantom) (including buffers, not shown) may be used or instantiated to enable control of multiple devices on a single scan chain 62. In such an event, sequences generated by each server 108, 108′, etc., may be combined, such as by merging module 109, and subsequently transmitted to the target board 120. Discrete commands, data, or other instructions intended for two or more respective targeted devices, may be properly positioned within a single bit stream to reach their intended target. For example, two commands intended for two serially adjacent devices, respectively, are placed serially adjacent to one another within a single bit stream. Similarly, bypass commands may also be appropriately placed within the bit stream to place any other (unselected/non-targeted) devices in the chain into bypass mode. Use of buffer 140, 140′, etc., enables a series of sequences for an individual session to be completed prior to sending them to the scan chain. This may facilitate the use of multiple, nominally simultaneous sessions, by providing a convenient source of combinable sequences for merging module 109.

Referring now to FIG. 5A, an exemplary method for emulating individual JTAG devices in a multiple device boundary scan chain in accordance with the teachings of the present invention is discussed. As shown, this method includes coupling 170 emulator 110 (FIGS. 1 and 5A) to the scan chain, and obtaining 172 the topology of the scan chain, e.g., using topology module 171 (FIG. 2). This obtaining 172 may be effected by the user inputting the information via a GUI, such as those of the visionXTREME™ (Wind River), or visionCLICK™ emulation/debugging tools, running on host system 112, 114, etc. Alternatively, module 171 (FIG. 2) may automatically 174 determine the topology. This information is then used to create the board description file as discussed hereinabove.

The method further includes selecting 176 at least one device 30, 30′, 30″, etc., (FIG. 1) within the scan chain, such as by using selection module 175 (FIG. 2). Selecting 176 may include generating 178 a selection instruction which, using data obtained from the board description file, informs the driver, and/or other system modules, how many IR/DR bypass bits are present before and after (i.e., upstream and downstream of, respectively) the targeted device(s) in scan chain 62 (FIG. 1).

Once the target(s) have been selected, JTAG scan chain sequences, used to communicate with the targeted device(s), are created 183. These scan chain sequences may include any desired combination of instructions and data, to implement desired operations such as debugging or emulation. As described in the above-referenced '250 application, the DEVNUM and associated functionality may be used to place the desired instructions/data at appropriate positions within a bit stream to reach the desired device. The JTAG scan chain sequences may be created using any convenient programming technique available to the skilled artisan. For example, in particular embodiments, a macro language may be used to conveniently define each step required to build the chains.

The method further includes generating 184 bypass sequences to place at least one other device 30′ in the scan chain 62 into bypass mode, using bypass module 181 (FIG. 2). Emulation sequences may be generated 188 (e.g., using emulation sequence module 187 of FIG. 2) which may then bypass the other device 30′ for execution by the target device(s) 30. In various embodiments, instruction generation 188 may include placing 190 the target device(s) 30 into data mode, and formatting 192 the emulation sequences to compensate for the other device(s).

Referring now to FIG. 5B, once a sequence is created 183, the device driver calls 194 the server in order to record 196 the sequence in the buffer 140 (FIG. 2). The recording 196 of a sequence may be completed in one of two modes, i.e., in Slow mode 198 or Fast mode 203. In a particular embodiment, the Slow mode includes storing a copy of the sequences in a macro language, in the memory (buffer 140) of the Server 108. In the Fast mode, the sequences are translated into bit streams that are then stored in buffer 140.

Recording in the Fast mode generally uses fewer system resources, so the recording advantageously completes relatively quickly, and consumes less memory within buffer 140. This advantage pertains because the scan chain sequences only vary from one another by a small percentage of the total number of bits, since most of the bits of the scan chain sequences correspond to control, empty zones, and overhead, associated with proper placement of the instruction/data properly in the sequence. For example, a write to a memory location of a device often requires only a modification of a small percentage (e.g., sometimes as little as about 1-10 percent) of the entire chain sequence relative to other chain sequences directed to the same device.

Thus, during the record phase of a sequence in fast mode 203, information on the pertinent aspects of the sequence, i.e., the instructions/data portion of the sequence, is stored in the Server 108 and linked to the sequence itself. Subsequent sequences may then be recorded simply by substituting a new instruction/data portion into an otherwise identical bit stream.

Once recorded into transmit buffer 142, any sequences recorded in Slow mode 198 (i.e., sequences that were not translated prior to recording) are translated 199 into corresponding bit streams. Then, the sequences associated with a given task may be played back 205. Playback 205 may take place in either Slow mode 207 or Fast mode 209. Fast mode 209 involves transmitting the sequences to the scan chain 62 of the target board 120 in a conventional manner, i.e., typically at as high a data transfer rate as possible. The Slow mode playback 207 is generally a step-by-step operation in which each sequence is transmitted independently, to enable a user to track the effect of each sequence. It should be evident that the choice of playback modes 207, 209, is nominally independent of the record mode chosen, so that sequences recorded in Slow mode 198 may be played back in Fast mode 209, and vice versa. Steps 176 to 209 may then be optionally repeated 212, to instantiate additional servers 108′ to effect additional sessions as discussed hereinabove.

Responses to the transmitted sequences, such as register status responses 166 and/or data values 169 (FIG. 4) may then be received 211 in receive buffer 144 (FIG. 2). These responses (in bit stream format) are then decoded (e.g., using server(s) 108, 108′ and/or driver(s) 132, 132′), such as by reversing the translation procedure(s) described hereinabove, and sent by OS 130 for display on host system 112, 114.

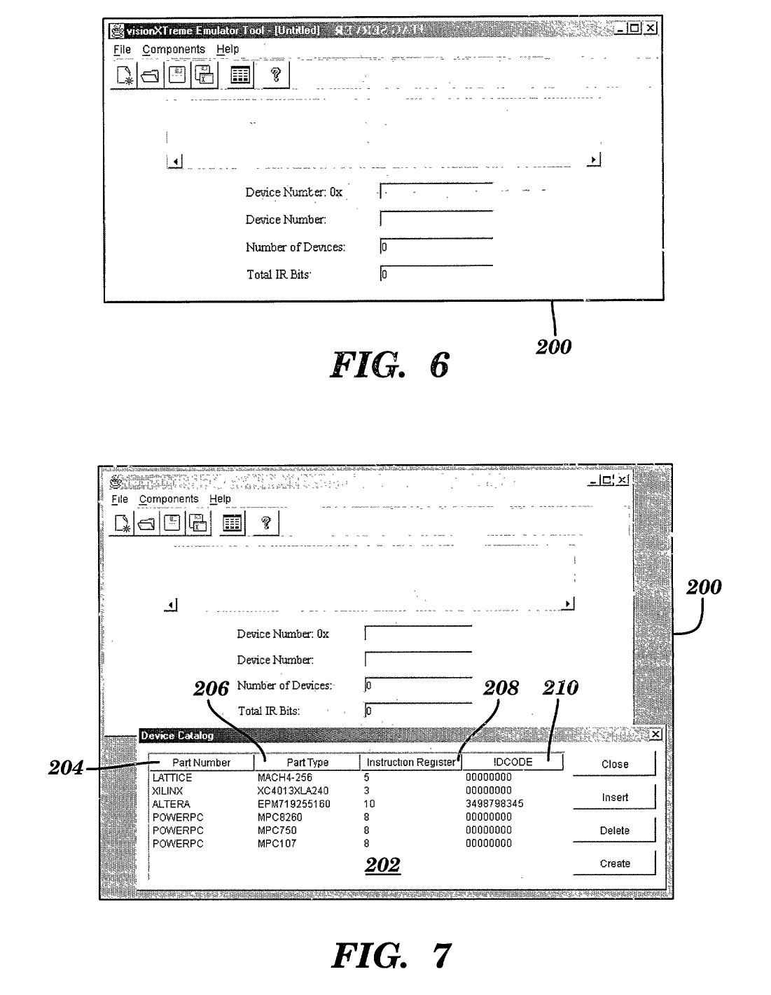

Turning now to FIGS. 6-10, examples of a GUI associated with emulator 110 of the present invention is shown. In this embodiment, the GUI includes the above-referenced visionXTREME™ product modified in accordance with teachings of the present invention.

Referring to FIG. 6, once a user couples emulator 110 to a scan chain 62, 62′, etc., substantially as shown in FIG. 1, to start a new project, the GUI displays a project window 200. The window 200 may be blank, and all data associated to the window may also be blank. Window 200 helps enable the user to define the serial scan chain 62, etc., including the topology thereof, on a particular board 60.

Turning to FIG. 7, the GUI enables the user to select devices from a list (e.g., library) 202. The library 202 includes various devices 30, 30′, etc., listed by manufacturer name 204, type 206, instruction register length 208, and the vector ID code 210. The vector ID code 210 is typically assigned by the manufacturer. The user may select one of the devices 30 from the list, or alternatively, the user may add new devices to the library 202 by entering the corresponding parameters thereof, including the instruction register length 208 and the vector ID code 210.

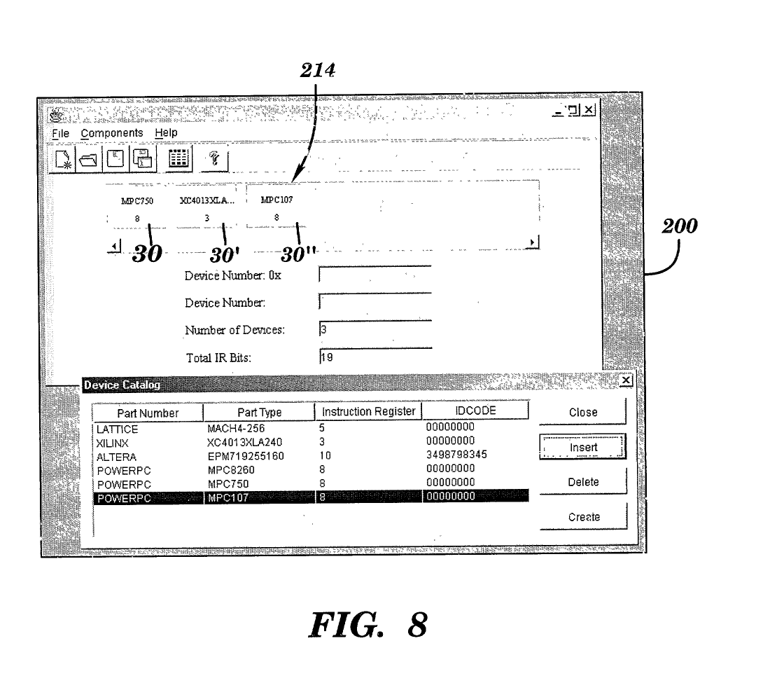

Referring now to FIG. 8, once devices 30, 30′, etc., in the particular scan chain have been added, the project window 200 displays a graphical representation 214 of the topology (e.g., the order of the devices within the scan chain) of the board 60.

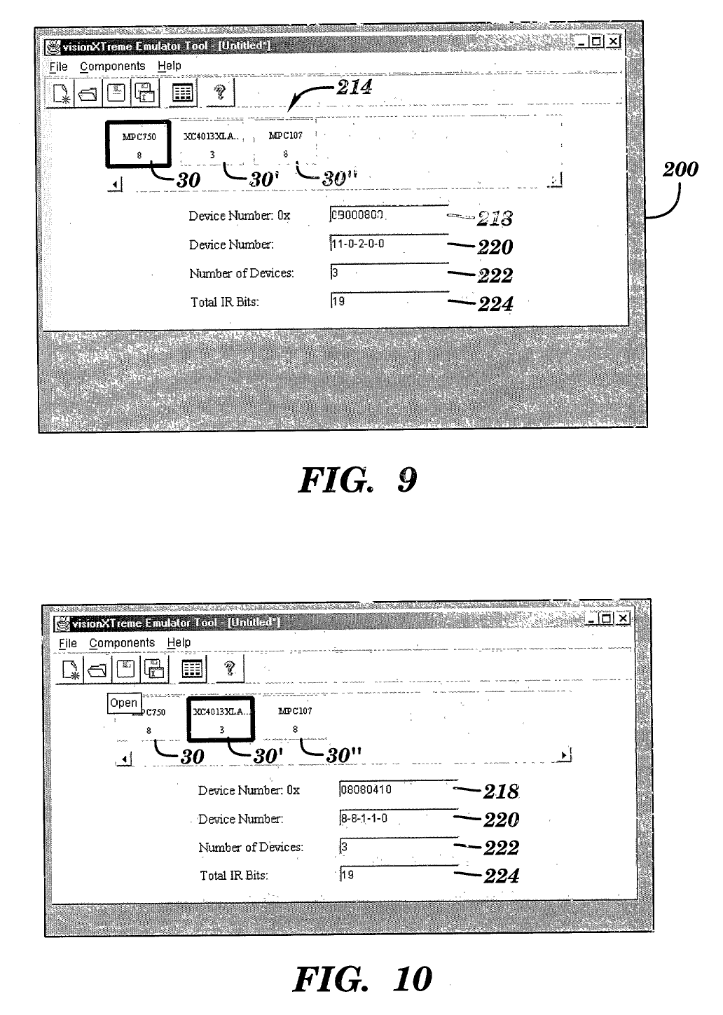

Turning now to FIGS. 9 and 10, the user may select a particular device (e.g., by clicking on the particular device in the graphical representation 214) to display information about this device. In the examples shown, device 30″ was selected in FIG. 9, while device 30′ was selected in FIG. 10. Window 200 may then display the DEVNUM in both hexadecimal and decimal notation in fields 218 and 220, respectively. The total number of devices 30, etc., in the scan chain 62, etc., is shown in field 222, while the total number of instruction register bits in the entire chain is shown in field 224. Once a particular device is selected as shown, emulator 110 places the devices within the scan chain 62, 62′ into their data phases.

The emulator 110 may then generate conventional emulation/debugging commands, which are modified as described hereinabove to compensate for the bits added by the bypassed devices 30′, etc, to properly position the particular commands. The emulator 110 also accounts for bits added by downstream bypassed devices so that the data delivered to the emulator from the selected device 30, etc., may be properly processed. Emulator 110 may now provide emulation/debugging services in a manner consistent with a conventional single chip JTAG emulation environment.

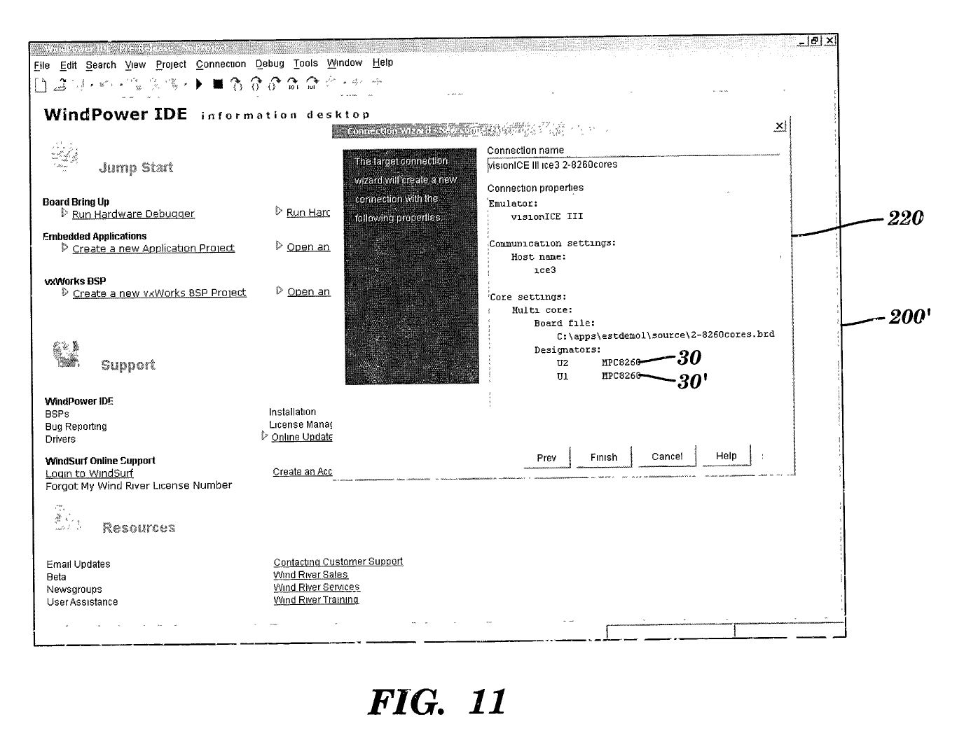

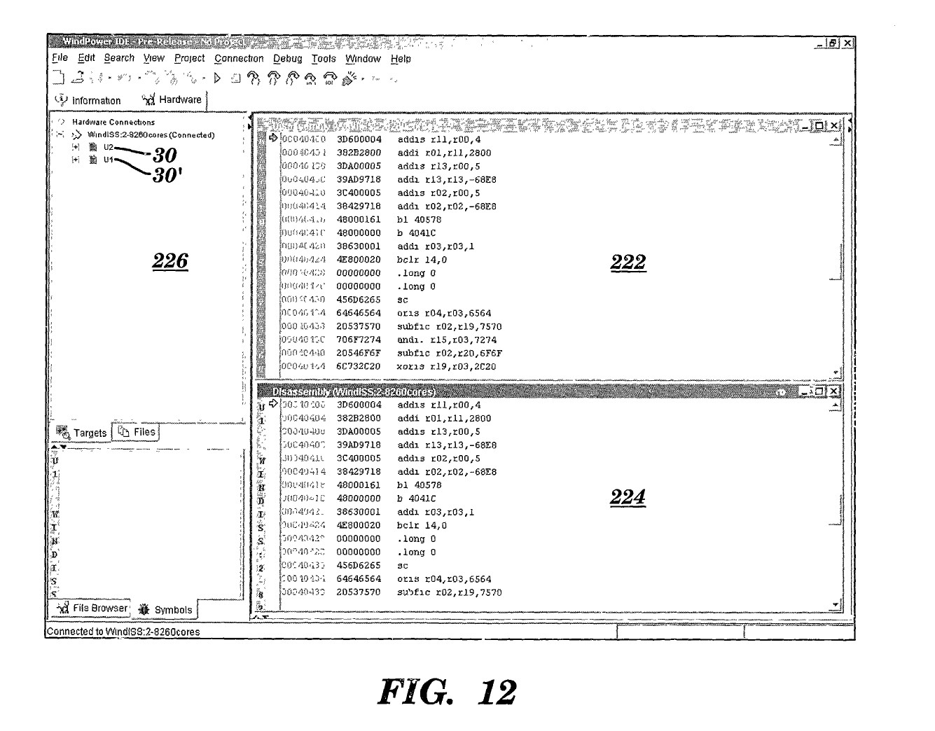

As discussed hereinabove, embodiments of the present invention may be configured to enable multiple sessions to be run simultaneously by instantiating multiple servers 108. A GUI associated with such embodiments is substantially similar to that shown and described with respect to FIGS. 6-10, with variations shown in FIGS. 11 and 12. As shown in FIG. 11, a window 200′ includes a panel 220 (e.g., of a session setup wizard) indicating that sessions for multiple targets 30, 30′ are set up. FIG. 12 shows windows 222, 224, which display the sessions associated with each device 30, 30′, respectively. A target navigator 226 shows each of the target devices that are being debugged/emulated.

Although the GUI of FIGS. 11 and 12 illustrates the implementation of two sessions using a single host 112, the skilled artisan will recognize that greater numbers of simultaneous sessions, may be used without departing from the spirit and scope of the present invention. Moreover, GUIs similar or identical to those described herein may also be used to implement multiple sessions on multiple discreet hosts 112, 114, without departing from the spirit and scope of the present invention.

As mentioned hereinabove, embodiments of the present invention may be used to load programmable devices such as FPGAs and EPLDs. An exemplary approach loading such devices is disclosed in U.S. patent application Ser. No. 10/083,224, entitled Multi-Core Controller, filed Feb. 26, 2002, which is fully incorporated by reference herein. Briefly described, a blank (i.e., unprogrammed/uninitialized) programmable device such as an FPGA 30′ (FIG. 1), typically includes a conventional hardware TAP controller, and blank logic cells (not shown). The TAP controller includes a conventional TRST input, and both the TAP controller and logic cells include conventional parallel TCK, TMS, and TDI inputs and TDO outputs. Once the FPGA 30′ is connected to the emulator 110 through scan chain 62, and via the TAP controller in a conventional manner, the TAP controller may be used to download logic from the emulator 110, via server 108.

In the preceding specification, the invention has been described with reference to specific exemplary embodiments thereof. It will be evident that various modifications and changes may be made thereunto without departing from the broader spirit and scope of the invention as set forth in the claims that follow. The specification and drawings are accordingly to be regarded in an illustrative rather than restrictive sense.

Having thus described the invention, what is claimed is:

1. A method for emulating individual devices in a multiple device chain, said method comprising:
effecting a session including:
selecting at least one target device within the chain;
actuating a server having a transmit buffer;
creating emulation sequences configured for execution by the at least one target device;
recording the emulation sequences in the transmit buffer; and
transmitting the recorded emulation sequences to the scan chain;
wherein the emulation sequences pass at least one other device on the scan chain and are executed by the target device.

2. The method of claim 1, wherein the session comprises:
creating bypass sequences, to place the at least one other device into bypass mode;
recording the bypass sequences in the transmit buffer; and
transmitting the recorded bypass sequences from the transmit buffer to the scan chain.

3. The method of claim 2, comprising translating the recorded bypass sequences and emulation sequences prior to said transmitting.

4. The method of claim 2, comprising communicably coupling an operating system to a device driver.

5. The method of claim 4, wherein said selecting comprises informing the driver of the number of bypass bits upstream and downstream of the target device in the chain.

6. The method of claim 4, wherein said creating bypass sequences and said creating emulation sequences are effected with the driver.

7. The method of claim 4, wherein said obtaining is effected with the operating system.

8. The method of claim 1, comprising effecting said recording in a slow mode.

9. The method of claim 1, comprising effecting said recording in a fast mode.

10. The method of claim 1, comprising effecting said transmitting the recorded emulation sequences in a fast mode.

11. The method of claim 1, comprising effecting said transmitting the recorded emulation sequences in a slow mode.

12. The method of claim 1, comprising receiving responses from the target device.

13. The method of claim 12, comprising recording the responses in a receive buffer disposed in the server.

14. The method of claim 1, comprising initiating an other session, said other session including actuating an other server having an other transmit buffer and an other receive buffer.

15. The method of claim 14, wherein the other session comprises:
creating other emulation sequences; and
recording the other emulation sequences in the other transmit buffer.

16. The method of claim 15, comprising transmitting the other emulation sequences to the target device.

17. The method of claim 16, comprising transmitting the other emulation sequences to an other target device within the scan chain.

18. The method of claim 1, comprising:
coupling a host to the emulator; and
effecting the session using a GUI running on the host.

19. The method of claim 18, comprising coupling the host directly to the emulator.

20. The method of claim 19, comprising coupling the host to the emulator through one of the group consisting of a parallel port and a USB port.

21. The method of claim 18, comprising coupling the host to the emulator through a network.

22. The method of claim 18, comprising effecting an other session using the GUI.

23. The method of claim 22, comprising effecting an other session for an other target device.

24. The method of claim 18, comprising effecting an other session using an other GUI running on an other host coupled to the emulator.

25. The method of claim 24, comprising selecting the same target device in both the session and the other session.

26. The method of claim 1, wherein the individual devices comprise JTAG devices and the chain includes a boundary scan chain.

27. The method of claim 26, wherein said effecting a session is effected by an emulator.

28. The method of claim 26, wherein said selecting comprises generating a selection instruction and sending the selection instruction to the scan chain.

29. The method of claim 1, wherein said creating emulation sequences comprises creating sequences configured to place the target device into a data mode.

30. The method of claim 29, wherein said transmitting the recorded emulation sequences includes formatting the emulation sequences to compensate for the at least one other device in the scan chain.

31. The method of claim 30, wherein said formatting includes compensating for bits added by the at least one other device.

32. The method of claim 26, wherein said obtaining the topology includes automatically determining the topology of the scan chain.

33. The method of claim 26, wherein the topology includes the number of devices in the scan chain, and the number of instruction register bits in each of the devices.

34. The method of claim 33, wherein the topology includes a device number for at least one of the devices within the scan chain.

35. The method of claim 26, wherein said selecting includes serially placing an instruction register of the target device into the scan chain.

36. The method of claim 26, wherein the emulator includes a debugger.

37. The method of claim 36, further comprising displaying a graphical representation of the scan chain.

38. The method of claim 37, wherein the graphical representation includes the topology of the scan chain.

39. The method of claim 38, wherein the topology includes the number of devices in the scan chain, and the number of instruction register bits in each of the devices.

40. The method of claim 1, comprising obtaining the topology of the chain.

41. A graphical user interface (GUI) for an emulator configured to emulate individual devices in a multiple device chain, said GUI comprising:
a user-selectable list of devices;
a graphical display of the chain;
at least one chain parameter field; and
a session field configured for identifying each of a plurality of emulation sessions.

42. The GUI of claim 41, wherein the individual devices comprise JTAG devices and the chain includes a boundary scan chain.

43. The GUI of claim 42, wherein said at least one chain parameter field displays a parameter selected from the group consisting of: number of devices in the scan chain; number of instruction register bits in the scan chain; and a device number for at least one of the devices.

44. The GUI of claim 42, wherein the graphical display comprises the number of devices in the scan chain, the model number of each device, the Instruction Register length of each device, and relative position of each device within the scan chain.

45. A system for emulating individual JTAG devices in a multiple device boundary scan chain, said system comprising:
a topology module configured to obtain the topology of the scan chain;
a selection module coupled to said topology module, said selection module configured to select a target device within the scan chain;
a server having a transmit buffer;
an emulation instruction module configured to generate emulation sequences configured for execution by the at least one target device;
said server configured to record the emulation sequences in the transmit buffer; and
said server configured to transmit the emulation sequences from the transmit buffer to the scan chain;
wherein the emulation sequences pass the at least one other device and are executed by the target device.

46. The system of claim 45, comprising a bypass module configured to generate bypass sequences to place the at least one other device into bypass mode.

47. A system for emulating individual JTAG devices in a multiple device boundary scan chain, said system comprising:
an operating system module; said operating system module including:
a topology module configured to obtain the topology of the scan chain;
a selection module configured to select a target device within the scan chain; and
an emulation instruction module configured to generate emulation sequences configured for execution by the target device and to bypass at least one other device for execution by the target device;
at least one driver coupled to the operating system;
a server having a transmit buffer;
said server configured to record the emulation sequences in the transmit buffer; and
said server configured to transmit the emulation sequences from the transmit buffer to the scan chain, wherein the emulation sequences bypass the other device and are executed by the target device.

48. An article of manufacture for emulating individual JTAG devices in a multiple device boundary scan chain, said article of manufacture comprising:
a computer usable medium having a computer readable program code embodied therein, said computer readable program code including instructions for:
effecting a session including:
selecting at least one target device within the chain;
instantiating a server having a transmit buffer;
creating emulation sequences configured for execution by the target device and to bypass at least one other device on the chain;
recording the emulation sequences in the transmit buffer; and
transmitting the recorded emulation sequences to the scan chain;
wherein the emulation sequences bypass the at least one other device and are executed by the target device.

49. Computer readable program code for emulating individual JTAG devices in a multiple device boundary scan chain, said computer readable program code comprising instructions to perform the following steps:
effecting a session including:
selecting at least one target device within the chain;
actuating a server having a transmit buffer;
creating emulation sequences configured to bypass at least one other device on the chain;
recording the emulation sequences in the transmit buffer; and
transmitting the recorded emulation sequences to the scan chain;
wherein the emulation sequences bypass the at least one other device and are executed by the target device.

50. A system for emulating individual JTAG devices in a multiple device boundary scan chain, said system comprising:
a topology module configured to obtain the topology of the scan chain;
a selection module coupled to said topology module, said selection module configured to select a target device within the scan chain;
a server having a transmit buffer;
an emulation instruction module configured to generate emulation sequences which bypass at least one other device in the scan chain;
said server configured to record the emulation sequences in the transmit buffer;
said server configured to transmit the emulation sequences from the transmit buffer to the scan chain, wherein the emulation sequences bypass the other device and are executed by the target device; and
a graphical user interface (GUI) including:
a user-selectable list of JTAG devices;
a graphical display of the chain;
at least one chain parameter field; and
a session field configured for identifying at least one emulation session.

51. An emulator comprising:
an emulator connector configured to couple to a scan chain;
a topology module configured to obtain the topology of the scan chain;
a selection module coupled to said topology module, said selection module configured to select a target device within the scan chain;
a server having a transmit buffer;
an emulation instruction module configured to generate emulation sequences which bypass at least one other device in the scan chain;
said server configured to record the emulation sequences in the transmit buffer; and
said server configured to transmit the emulation sequences from the transmit buffer to the scan chain;
a translation module configured to translate the emulation sequences into a format usable by the target device;
wherein the emulation sequences bypass the other device and are executed by the target device.
